(19) United States
(12) Patent Application Publication
(10) Pub. No.: US 2022/0417777 A1
(43) Pub. Date: Dec. 29, 2022

(54) Terminal Device, Network Device and Methods Therein

(71) Applicant: Telefonaktiebolaget LM Ericsson (publ), Stockholm (SE)

(72) Inventors: Antonino Orsino, Kirkkonummi (FI); Congchi Zhang, Shanghai (CN); Zhang Zhang, Beijing (CN)

(21) Appl. No.: 17/780,766

(22) PCT Filed: Jan. 15, 2021
(86) PCT No.: PCT/CN2021/072113

§ 371 Date: May 27, 2022

(30) Foreign Application Priority Data
Jan. 21, 2020 (CN) PCT/CN2020/073471

(51) Int. Cl. H04W 24/10; H04W 76/19

(52) U.S. Cl. CPC H04W 24/10; H04W 76/19; H04W 92/18

(57) ABSTRACT

The present disclosure provides a method (400) in a first terminal device. The method (400) includes: transmitting (410) a first message indicating a first sidelink Access Stratum, AS, configuration to a second terminal device; receiving (420) from the second terminal device a second message indicating a failure of the first sidelink AS configuration; and transmitting (430) to a network device a report regarding the failure of the first sidelink AS configuration. The report contains one or more of: an indicator indicating the failure of the first sidelink AS configuration, or an identification of the second terminal device.

### TECHNICAL FIELD

The present disclosure relates to wireless communications, and more particularly, to a terminal device, a network device and methods therein.

### BACKGROUND

Cellular Intelligent Transport System (C-ITS) aims at defining a new cellular eco-system for delivery and dissemination of vehicular services. Such eco-systems include e.g., short range and long range communications for Vehicle-to-Everything (V2X) service, as shown in FIG. 1. In particular, the short range communications involve transmissions over Device-to-Device (D2D) links, also defined as sidelinks or PC5 links in the 3^{rd} Generation Partnership Project (3GPP), towards other vehicular User Equipments (UEs) or Road Side Units (RSUs). On the other hand, long range communications involve transmissions over a Uu interface between a UE and a base station, allowing data to be disseminated to different ITS service providers including road traffic authorities, road operators, automotive Original Equipment Manufacturers (OEMs), cellular operators, and the like.

The initial standardization effort for the sidelink in the 3GPP dates back to Release 12, targeting public safety use cases. Since then, a number of enhancements have been introduced with the objective to increase use cases that could benefit from the D2D technology. In particular, in the Long Term Evolution (LTE) Release 14 and Release 15, extensions of the D2D technology provide support of V2X communications, including any combination of direct communications between vehicles, pedestrians and infrastructures.

While the V2X in the LTE mainly aims at traffic safety services, in New Radio (NR), V2X has a much broader scope including not only basic safety services but also non-safety applications, such as sensor/data sharing between vehicles with the objective to strengthen a perception of a surrounding environment. Hence, a new set of applications, such as vehicles platooning, cooperative maneuver between vehicles, and remote/autonomous driving, may utilize such enhanced sidelink framework.

In view of this, various requirements on data rates, capacities, reliabilities, latencies, and/or communication ranges are made more stringent. For example, given a variety of services that can be transmitted over the sidelink, a robust Quality of Service (QoS) framework which takes into account different performance requirements of different V2X services is desired. Additionally, new radio protocols for handling more robust communications are to be designed. All of these are currently under the investigation of the 3GPP in the NR Release16.

For a sidelink in the NR, unicasts at the Access Stratum (AS) are supported for services requiring high reliabilities. As shown in FIG. 2, between a pair of UEs (UE 1 and UE 2), there can be multiple unicast sidelinks each supporting multiple sidelink QoS flows or Radio Bearers (RBs). At the AS, each link can be identified by a source Layer 2 (L2) Identification (ID) and a destination L2 ID. For instance, in FIG. 2, a PC5 unicast link 1 can include three QoS flows: PC5 QoS Flow #1, PC5 QoS Flow #2, and PC5 QoS Flow #3, and can be identified by a pair of an L2 ID1 corresponding to an Application ID 1 and an L2 ID2 corresponding to an Application ID 2.

A Radio Link Failure (RLF) procedure is supported for the sidelink in the NR. A sidelink RLF can be declared when a low link quality is detected, e.g., in particular when one or more of the following criteria are met:
a timer started upon receiving an indication of a radio problem (e.g. out of sync) from the physical layer expires,
a maximum number of Radio Link Control (RLC) retransmissions has been reached,
a maximum number of consecutive Hybrid Automatic Repeat reQuest (HARQ) Negative Acknowledgement (NACK) feedbacks has been reached; or
a Channel Busy Ratio (CBR) is higher than a threshold value.

### SUMMARY

In addition, a UE may configure a unicast sidelink or Sidelink Radio Bearer (SLRB) that is to be established or reconfigure a unicast sidelink or SLRB that has already been established. FIG. 3 shows a sidelink AS configuration procedure via Radio Resource Control (RRC) signaling over a PC5 interface. As shown, at 3.1, an initiating UE (UE 1) signals an AS configuration it intends to use for a PC5 link or SLRB to a peer UE (UE 2). An AS configuration may include configuration parameters such as an RLC transmission mode (e.g., Unacknowledged Mode (UM) or Acknowledged Mode (AM)), a Sidelink Radio Bearer (SLRB) configuration parameter (e.g., QoS), or Packet Data Convergence Protocol (PDCP) or RLC configuration parameters. If UE 2 is able to comply with the AS configuration, it can initiate, at 3.2a, an AS Configuration Complete procedure towards UE 1 via RRC signaling over the PC5 interface; or otherwise it can initiate, at 3.2b, an AS Configuration Failure procedure towards UE 1 via RRC signaling over the PC5 interface. A sidelink RLF can also be declared when UE 1 and UE 2 fail to align their respective AS configurations with each other.

In the NR Release 16, UE behaviors in case of a sidelink RLF due to a low link quality have been agreed. However, there is still a need for further defining UE/network behaviors in case of sidelink Access Stratum (AS) configuration failure.

According to a first aspect of the present disclosure, a method in a first terminal device is provided. The method includes: transmitting a first message indicating a first sidelink AS configuration to a second terminal device; receiving from the second terminal device a second message indicating a failure of the first sidelink AS configuration; and transmitting to a network device a report regarding the failure of the first sidelink AS configuration. The report contains one or more of: an indicator indicating the failure of the first sidelink AS configuration, or an identification of the second terminal device.

In an embodiment, the second message may further indicate one or more configuration parameters that the second terminal device is not able to comply with in the first sidelink AS configuration, and the report may contain the one or more configuration parameters.

In an embodiment, the one or more configuration parameters may include an SLRB configuration parameter.

In an embodiment, the report may further contain one or more of: an identification of the first terminal device; or an identification of an SLRB associated with the failure.

In an embodiment, the method may further include: transmitting to the second terminal device a third message indicating a second sidelink AS configuration in response to the second message.

In an embodiment, the second sidelink AS configuration may contain a full sidelink AS configuration or a difference from the first sidelink AS configuration.

In an embodiment, the second message may further indicate one or more configuration parameters that the second terminal device is not able to comply with in the first sidelink AS configuration, and the second sidelink AS configuration may be determined based on the one or more configuration parameters.

In an embodiment, the one or more configuration parameters may include an SLRB configuration parameter.

In an embodiment, the second message may further indicate at least one candidate sidelink AS configuration that the second terminal device is able to comply with, and the second sidelink AS configuration may be selected from the at least one candidate sidelink AS configuration.

In an embodiment, the method may further include: receiving a fourth message indicating the second sidelink AS configuration from the network device.

According to a second aspect of the present disclosure, a first terminal device is provided. The first terminal device includes: a transmitting unit configured to transmit a first message indicating a first sidelink AS configuration to a second terminal device; and a receiving unit configured to receive from the second terminal device a second message indicating a failure of the first sidelink AS configuration. The transmitting unit is further configured to transmit to a network device a report regarding the failure of the first sidelink AS configuration. The report contains one or more of: an indicator indicating the failure of the first sidelink AS configuration, or an identification of the second terminal device.

The respective embodiments and features described above in connection with the first aspect also apply to the second aspect.

According to a third aspect of the present disclosure, a first terminal device is provided. The first terminal device includes a transceiver, a processor and a memory. The memory contains instructions executable by the processor whereby the first terminal device is operative to: transmit a first message indicating a first sidelink AS configuration to a second terminal device; receive from the second terminal device a second message indicating a failure of the first sidelink AS configuration; and transmit to a network device a report regarding the failure of the first sidelink AS configuration. The report contains one or more of: an indicator indicating the failure of the first sidelink AS configuration, or an identification of the second terminal device.

In an embodiment, the memory may further contain instructions executable by the processor whereby the first terminal device is operative to perform the method according to the above first aspect.

According to a fourth aspect of the present disclosure, a computer readable storage medium is provided. The computer readable storage medium has computer program instructions stored thereon. The computer program instructions, when executed by a processor in a first terminal device, cause the first terminal device to: transmit a first message indicating a first sidelink AS configuration to a second terminal device; receive from the second terminal device a second message indicating a failure of the first sidelink AS configuration; and transmit to a network device a report regarding the failure of the first sidelink AS configuration. The report contains one or more of: an indicator indicating the failure of the first sidelink AS configuration, or an identification of the second terminal device.

In an embodiment, the computer program instructions, when executed by the processor in the first terminal device, may further cause the first terminal device to perform the method according to the above first aspect.

According to a fifth aspect of the present disclosure, a method in a first terminal device is provided. The method includes: transmitting a first message indicating a sidelink AS configuration to a second terminal device; receiving from the second terminal device a second message indicating a failure of the sidelink AS configuration; and releasing a sidelink connection or an SLRB associated with the failure.

In an embodiment, the sidelink connection or the SLRB may be released in response to determining that no other sidelink AS configuration is usable for the sidelink connection or the SLRB.

In an embodiment, the second message may further indicate one or more configuration parameters that the second terminal device is not able to comply with in the sidelink AS configuration. It can be determined based on the one or more configuration parameters that no other sidelink AS configuration is usable for the sidelink connection or the SLRB.

In an embodiment, the one or more configuration parameters may include an SLRB configuration parameter.

In an embodiment, the second message may further indicate at least one candidate sidelink AS configuration that the second terminal device is able to comply with. It can be determined based on the at least one candidate sidelink AS configuration that no other sidelink AS configuration is usable for the sidelink connection or the SLRB.

In an embodiment, the method may further include: transmitting to a network device a notification that the sidelink connection or the SLRB has been released.

In an embodiment, the method may further include: transmitting to a network device a report regarding the failure of the sidelink AS configuration; and receiving from the network device an indication that no other sidelink AS configuration is usable for the sidelink connection or the SLRB. The sidelink connection or the SLRB may be released in response to receiving the indication.

In an embodiment, the second message may further indicate one or more configuration parameters that the second terminal device is not able to comply with in the sidelink AS configuration. The report may contain the one or more configuration parameters.

In an embodiment, the one or more configuration parameters may include an SLRB configuration parameter.

In an embodiment, the report may contain one or more of: an indicator indicating the failure of the sidelink AS configuration, an identification of the first terminal device and an identification of the second terminal device, or an identification of the SLRB.

According to a sixth aspect of the present disclosure, a first terminal device is provided. The first terminal device includes: a transmitting unit configured to transmit first message indicating a sidelink AS configuration to a second terminal device; a receiving unit configured to receive from the second terminal device a second message indicating a failure of the sidelink AS configuration; and a releasing unit configured to release a sidelink connection or an SLRB associated with the failure.

The respective embodiments and features described above in connection with the fifth aspect also apply to the sixth aspect.

According to a seventh aspect of the present disclosure, a first terminal device is provided. The first terminal device includes a transceiver, a processor and a memory. The memory contains instructions executable by the processor whereby the first terminal device is operative to: transmit a first message indicating a sidelink AS configuration to a second terminal device; receive from the second terminal device a second message indicating a failure of the sidelink AS configuration; and release a sidelink connection or an SLRB associated with the failure.

In an embodiment, the memory may further contain instructions executable by the processor whereby the first terminal device is operative to perform the method according to the above fifth aspect.

According to an eighth aspect of the present disclosure, a computer readable storage medium is provided. The computer readable storage medium has computer program instructions stored thereon. The computer program instructions, when executed by a processor in a first terminal device, cause the first terminal device to: transmit a first message indicating a sidelink AS configuration to a second terminal device; receive from the second terminal device a second message indicating a failure of the sidelink AS configuration; and release a sidelink connection or an SLRB associated with the failure.

In an embodiment, the computer program instructions, when executed by the processor in the first terminal device, may further cause the first terminal device to perform the method according to the above fifth aspect.

According to a ninth aspect of the present disclosure, a method in a second terminal device is provided. The method includes: receiving from a first terminal device a first message indicating a sidelink AS configuration; and transmitting to the first terminal device a second message indicating a failure of the sidelink AS configuration. The second message further indicates one or more configuration parameters that the second terminal device is not able to comply with in the sidelink AS configuration, or at least one candidate sidelink AS configuration that the second terminal device is able to comply with.

In an embodiment, the one or more configuration parameters may include an SLRB configuration parameter.

According to a tenth aspect of the present disclosure, a second terminal device is provided. The second terminal device includes: a receiving unit configured to receive from a first terminal device a first message indicating a sidelink AS configuration; and a transmitting unit configured to transmit to the first terminal device a second message indicating a failure of the sidelink AS configuration. The second message further indicates one or more configuration parameters that the second terminal device is not able to comply with in the sidelink AS configuration, or at least one candidate sidelink AS configuration that the second terminal device is able to comply with.

The respective embodiments and features described above in connection with the ninth aspect also apply to the tenth aspect.

According to an eleventh aspect of the present disclosure, a second terminal device is provided. The second terminal device includes a transceiver, a processor and a memory. The memory contains instructions executable by the processor whereby the second terminal device is operative to: receive from a first terminal device a first message indicating a sidelink AS configuration; and transmit to the first terminal device a second message indicating a failure of the sidelink AS configuration. The second message further indicates one or more configuration parameters that the second terminal device is not able to comply with in the sidelink AS configuration, or at least one candidate sidelink AS configuration that the second terminal device is able to comply with.

In an embodiment, the memory may further contain instructions executable by the processor whereby the second terminal device is operative to perform the method according to the above ninth aspect.

According to a twelfth aspect of the present disclosure, a computer readable storage medium is provided. The computer readable storage medium has computer program instructions stored thereon. The computer program instructions, when executed by a processor in a second terminal device, cause the second terminal device to: receive from a first terminal device a first message indicating a sidelink AS configuration; and transmit to the first terminal device a second message indicating a failure of the sidelink AS configuration. The second message further indicates one or more configuration parameters that the second terminal device is not able to comply with in the sidelink AS configuration, or at least one candidate sidelink AS configuration that the second terminal device is able to comply with.

In an embodiment, the computer program instructions, when executed by the processor in the second terminal device, may further cause the second terminal device to perform the method according to the above ninth aspect.

According to a thirteenth aspect of the present disclosure, a method in a second terminal device is provided. The method includes: receiving from a first terminal device a first message indicating a sidelink AS configuration; detecting a failure of the sidelink AS configuration at the second terminal device; and releasing a sidelink connection or an SLRB associated with the failure.

In an embodiment, the method may further include: transmitting to the first terminal device a second message indicating that the sidelink connection or the SLRB has been released.

According to a fourteenth aspect of the present disclosure, a second terminal device is provided. The second terminal device includes: a receiving unit configured to receive from a first terminal device a first message indicating a sidelink AS configuration; a detecting unit configured to detect a failure of the sidelink AS configuration at the second terminal device; and a releasing unit configured to release a sidelink connection or an SLRB associated with the failure.

The respective embodiments and features described above in connection with the thirteenth aspect also apply to the fourteenth aspect.

According to a fifteenth aspect of the present disclosure, a second terminal device is provided. The second terminal device includes a transceiver, a processor and a memory. The memory contains instructions executable by the processor whereby the second terminal device is operative to: receive from a first terminal device a first message indicating a sidelink AS configuration; detect a failure of the sidelink AS configuration at the second terminal device; and release a sidelink connection or an SLRB associated with the failure.

In an embodiment, the memory may further contain instructions executable by the processor whereby the second terminal device is operative to perform the method according to the above thirteenth aspect.

According to a sixteenth aspect of the present disclosure, a computer readable storage medium is provided. The computer readable storage medium has computer program instructions stored thereon. The computer program instructions, when executed by a processor in a second terminal device, cause the second terminal device to: receive from a first terminal device a first message indicating a sidelink AS configuration; detect a failure of the sidelink AS configuration at the second terminal device; and release a sidelink connection or an SLRB associated with the failure.

In an embodiment, the computer program instructions, when executed by the processor in the second terminal device, may further cause the second terminal device to perform the method according to the above thirteenth aspect.

According to a seventeenth aspect of the present disclosure, a method in a network device is provided. The method includes: receiving from a first terminal device a report regarding a failure of a first sidelink AS configuration for a sidelink connection between the first terminal device and a second terminal device. The report contains one or more of: an indicator indicating the failure of the first sidelink AS configuration, or an identification of the second terminal device.

In an embodiment, the report may further contain one or more of: an identification of the first terminal device, or an identification of an SLRB associated with the failure.

In an embodiment, the method may further include: transmitting to the first terminal device a message indicating a second sidelink AS configuration for the sidelink connection.

In an embodiment, the second sidelink AS configuration may contain a full sidelink AS configuration or a difference from the first sidelink AS configuration.

In an embodiment, the report may further indicate one or more configuration parameters that the second terminal device is not able to comply with in the first sidelink AS configuration, and the second sidelink AS configuration may be determined based on the one or more configuration parameters.

In an embodiment, the one or more configuration parameters may include an SLRB configuration parameter.

According to an eighteenth aspect of the present disclosure, a network device is provided. The network device includes: a receiving unit configured to receive from a first terminal device a report regarding a failure of a first sidelink AS configuration for a sidelink connection between the first terminal device and a second terminal device. The report contains one or more of: an indicator indicating the failure of the first sidelink AS configuration, or an identification of the second terminal device.

The respective embodiments and features described above in connection with the seventeenth aspect also apply to the eighteenth aspect.

According to a nineteenth aspect of the present disclosure, a network device is provided. The network device includes a transceiver, a processor and a memory. The memory contains instructions executable by the processor whereby the network device is operative to: receive from a first terminal device a report regarding a failure of a first sidelink AS configuration for a sidelink connection between the first terminal device and a second terminal device. The report contains one or more of: an indicator indicating the failure of the first sidelink AS configuration, or an identification of the second terminal device.

In an embodiment, the memory may further contain instructions executable by the processor whereby the network device is operative to perform the method according to the above seventeenth aspect.

According to a twentieth aspect of the present disclosure, a computer readable storage medium is provided. The computer readable storage medium has computer program instructions stored thereon. The computer program instructions, when executed by a processor in a network device, cause the network device to: receive from a first terminal device a report regarding a failure of a first sidelink AS configuration for a sidelink connection between the first terminal device and a second terminal device. The report contains one or more of: an indicator indicating the failure of the first sidelink AS configuration, or an identification of the second terminal device.

In an embodiment, the computer program instructions, when executed by the processor in the network device, may further cause the network device to perform the method according to the above seventeenth aspect.

According to a twenty-first aspect of the present disclosure, a method in a network device is provided. The method includes: receiving from a first terminal device a report regarding a failure of a sidelink AS configuration for a sidelink connection or an SLRB between the first terminal device and a second terminal device; and transmitting to the first terminal device an indication that no other sidelink AS configuration is usable for the sidelink connection or the SLRB.

In an embodiment, the report may further indicate one or more configuration parameters that the second terminal device is not able to comply with in the sidelink AS configuration. The method may further include: determining that no other sidelink AS configuration is usable for the sidelink connection or the SLRB based on the one or more configuration parameters.

In an embodiment, the one or more configuration parameters may include an SLRB configuration parameter.

In an embodiment, the report may contain one or more of: an indicator indicating the failure of the sidelink AS configuration, an identification of the first terminal device and an identification of the second terminal device, or an identification of the SLRB.

In an embodiment, the method may further include: receiving from the first terminal device a notification that the sidelink connection or the SLRB has been released.

According to a twenty-second aspect of the present disclosure, a network device is provided. The network device includes: a receiving unit configured to receive from a first terminal device a report regarding a failure of a sidelink AS configuration for a sidelink connection or an SLRB between the first terminal device and a second terminal device; and a transmitting unit configured to transmit to the first terminal device an indication that no other sidelink AS configuration is usable for the sidelink connection or the SLRB.

The respective embodiments and features described above in connection with the twenty-first aspect also apply to the twenty-second aspect.

According to a twenty-third aspect of the present disclosure, a network device is provided. The network device includes a transceiver, a processor and a memory. The memory contains instructions executable by the processor whereby the network device is operative to: receive from a first terminal device a report regarding a failure of a sidelink AS configuration for a sidelink connection or an SLRB between the first terminal device and a second terminal device; and transmit to the first terminal device an indication that no other sidelink AS configuration is usable for the sidelink connection or the SLRB.

In an embodiment, the memory may further contain instructions executable by the processor whereby the network device is operative to perform the method according to the above twenty-first aspect.

According to a twenty-fourth aspect of the present disclosure, a computer readable storage medium is provided. The computer readable storage medium has computer program instructions stored thereon. The computer program instructions, when executed by a processor in a network device, cause the network device to: receive from a first terminal device a report regarding a failure of a sidelink AS configuration for a sidelink connection or an SLRB between the first terminal device and a second terminal device; and transmit to the first terminal device an indication that no other sidelink AS configuration is usable for the sidelink connection or the SLRB.

In an embodiment, the computer program instructions, when executed by the processor in the network device, may further cause the network device to perform the method according to the above twenty-first aspect.

According to a twenty-fifth aspect of the present disclosure, a communication system is provided. The communication system includes a host computer including: processing circuitry configured to provide user data; and a communication interface configured to forward the user data to a cellular network for transmission to a UE. The cellular network includes a base station having a radio interface and processing circuitry. The base station's processing circuitry is configured to perform the method according to the seventeenth or twenty-first aspect.

In an embodiment, the communication system can further include the base station.

In an embodiment, the communication system can further include the UE. The UE is configured to communicate with the base station.

In an embodiment, the processing circuitry of the host computer can be configured to execute a host application, thereby providing the user data. The UE can include processing circuitry configured to execute a client application associated with the host application.

According to a twenty-sixth aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station. The base station can perform the method according to the seventeenth or twenty-first aspect.

In an embodiment, the method further can include: at the base station, transmitting the user data.

In an embodiment, the user data can be provided at the host computer by executing a host application. The method can further include: at the UE, executing a client application associated with the host application.

According to a twenty-seventh aspect of the present disclosure, a communication system is provided. The communication system includes a host computer including: processing circuitry configured to provide user data; and a communication interface configured to forward user data to a cellular network for transmission to a UE. The UE includes a radio interface and processing circuitry. The UE's processing circuitry is configured to perform the method according to the first, fifth, ninth, or thirteenth aspect.

In an embodiment, the communication system can further include the UE.

In an embodiment, the cellular network can further include a base station configured to communicate with the UE.

In an embodiment, the processing circuitry of the host computer can be configured to execute a host application, thereby providing the user data. The UE's processing circuitry can be configured to execute a client application associated with the host application.

According to a twenty-eighth aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station. The UE can perform the method according to the first, fifth, ninth, or thirteenth aspect.

In an embodiment, the method can further include: at the UE, receiving the user data from the base station.

According to a twenty-ninth aspect of the present disclosure, a communication system is provided. The communication system includes a host computer including: a communication interface configured to receive user data originating from a transmission from a UE to a base station. The UE includes a radio interface and processing circuitry. The UE's processing circuitry is configured to: perform the method according to the first, fifth, ninth, or thirteenth aspect.

In an embodiment, the communication system can further include the UE.

In an embodiment, the communication system can further include the base station. The base station can include a radio interface configured to communicate with the UE and a communication interface configured to forward to the host computer the user data carried by a transmission from the UE to the base station.

In an embodiment, the processing circuitry of the host computer can be configured to execute a host application. The UE's processing circuitry can be configured to execute a client application associated with the host application, thereby providing the user data.

In an embodiment, the processing circuitry of the host computer can be configured to execute a host application, thereby providing request data. The UE's processing circuitry can be configured to execute a client application associated with the host application, thereby providing the user data in response to the request data.

According to a thirtieth aspect of the present disclosure, a method is provided. The method is implemented in a communication system including a host computer, a base station and a UE. The method includes: at the host computer, receiving user data transmitted to the base station from the UE. The UE can perform the method according to the first, fifth, ninth, or thirteenth aspect.

In an embodiment, the method can further include: at the UE, providing the user data to the base station.

In an embodiment, the method can further include: at the UE, executing a client application, thereby providing the user data to be transmitted; and at the host computer, executing a host application associated with the client application.

In an embodiment, the method can further include: at the UE, executing a client application; and at the UE, receiving input data to the client application, the input data being provided at the host computer by executing a host application associated with the client application. The user data to be transmitted is provided by the client application in response to the input data.

According to a thirty-first aspect of the present disclosure, a communication system is provided. The communication system includes a host computer including a communication interface configured to receive user data originating from a transmission from a UE to a base station. The base station includes a radio interface and processing circuitry. The base station's processing circuitry is configured to perform the method according to the seventeenth or twenty-first aspect.

In an embodiment, the communication system can further include the base station.

In an embodiment, the communication system can further include the UE. The UE can be configured to communicate with the base station.

In an embodiment, the processing circuitry of the host computer can be configured to execute a host application; the UE can be configured to execute a client application associated with the host application, thereby providing the user data to be received by the host computer.

According to a thirty-second aspect of the present disclosure, a method is provided. The method is implemented in a communication system including a host computer, a base station and a UE. The method includes: at the host computer, receiving, from the base station, user data originating from a transmission which the base station has received from the UE. The base station can perform the method according to the seventeenth or twenty-first aspect.

In an embodiment, the method can further include: at the base station, receiving the user data from the UE.

In an embodiment, the method can further include: at the base station, initiating a transmission of the received user data to the host computer.

With the embodiments of the present disclosure, when a first terminal device receives from a second terminal device a message indicating that a first sidelink AS configuration proposed by the first terminal device fails at the second terminal device, the first terminal device can report the failure to a network device or release a sidelink connection or an SLRB associated with the failure. Additionally, the first terminal device can also signal a second sidelink AS configuration to the second terminal device. This allows the first terminal device, the second terminal device, and the network device to handle the sidelink AS configuration failure properly.

### BRIEF DESCRIPTION OF THE DRAWINGS

The above and other objects, features and advantages will be more apparent from the following description of embodiments with reference to the figures, in which:

FIG. 1 is a schematic diagram showing an architecture of a V2X system;

FIG. 2 is a schematic diagram showing an example of PC5 unicast links between UEs;

FIG. 3 is a sequence diagram of an example of a sidelink AS configuration procedure;

FIG. 4 is a flowchart illustrating a method in a terminal device according to an embodiment of the present disclosure;

FIG. 5 is a flowchart illustrating a method in a terminal device according to another embodiment of the present disclosure;

FIG. 6 is a flowchart illustrating a method in a terminal device according to yet another embodiment of the present disclosure;

FIG. 7 is a flowchart illustrating a method in a terminal device according to still another embodiment of the present disclosure;

FIG. 8 is a flowchart illustrating a method in a network device according to an embodiment of the present disclosure;

FIG. 9 is a flowchart illustrating a method in a network device according to another embodiment of the present disclosure;

FIG. 10 is a block diagram of a terminal device according to an embodiment of the present disclosure;

FIG. 11 is a block diagram of a terminal device according to another embodiment of the present disclosure;

FIG. 12 is a block diagram of a terminal device according to yet another embodiment of the present disclosure;

FIG. 13 is a block diagram of a terminal device according to still another embodiment of the present disclosure;

FIG. 14 is a block diagram of a terminal device according to still yet another embodiment of the present disclosure;

FIG. 15 is a block diagram of a network device according to an embodiment of the present disclosure;

FIG. 16 is a block diagram of a network device according to another embodiment of the present disclosure;

FIG. 17 schematically illustrates a telecommunication network connected via an intermediate network to a host computer;

FIG. 18 is a generalized block diagram of a host computer communicating via a base station with a user equipment over a partially wireless connection; and

FIGS. 19 to 22 are flowcharts illustrating methods implemented in a communication system including a host computer, a base station and a user equipment.

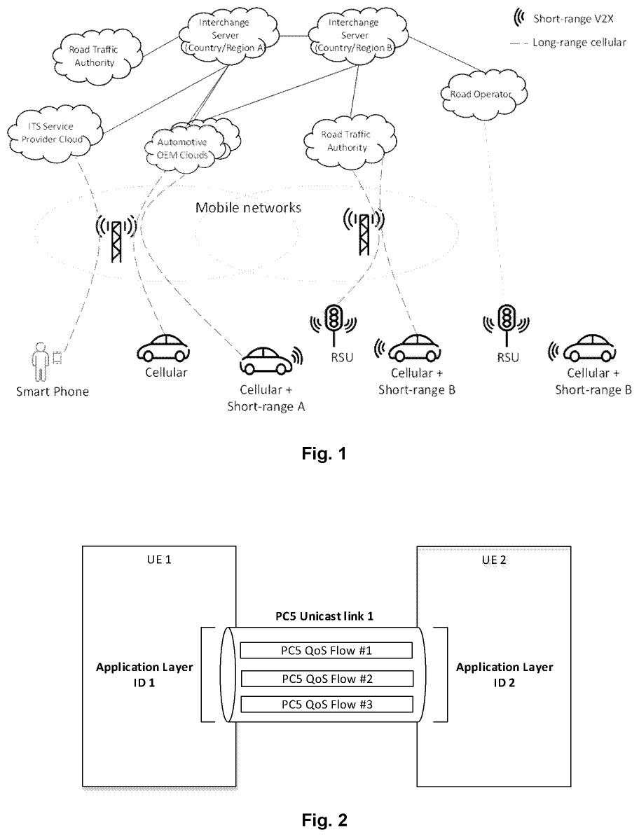

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or a (next) generation (gNB), a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network device to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

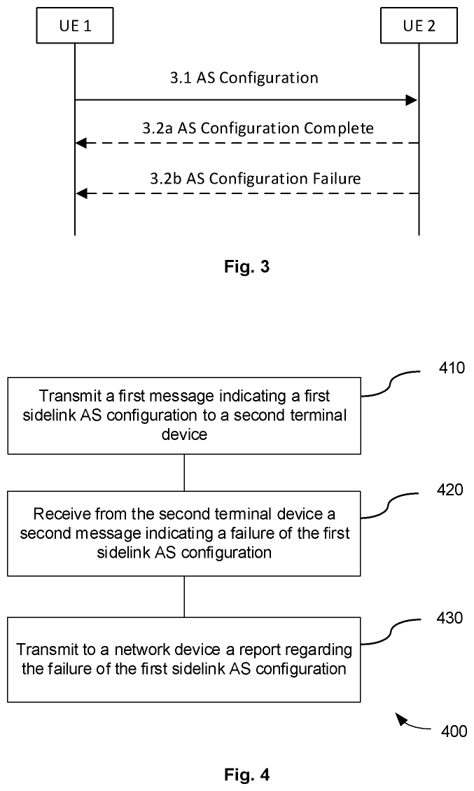

FIG. 4 is a flowchart illustrating a method 400 according to an embodiment of the present disclosure. The method 400 can be performed at a first terminal device, e.g., UE 1 in FIG. 3.

At block 410, a first message (referred to as e.g., RRCReconfigurationSidelink) indicating a first sidelink AS configuration is transmitted to a second terminal device (e.g., UE 2 in FIG. 3). The first sidelink AS configuration can be a sidelink AS configuration the first terminal device intends to use for a sidelink connection between the first and second terminal devices. As described above, a sidelink AS configuration may include configuration parameters such as SLRB configuration parameters and/or PDCP/RLC configuration parameters. The first message can be transmitted via RRC signaling over a PC5 link (i.e., a sidelink connection).

Here, the first sidelink AS configuration can be obtained by the first terminal device from a network device (e.g., a gNB) via dedicated signaling (e.g., while the first terminal device is in an RRC_CONNECTED state) or via System Information Broadcast (SIB) (e.g., while the first terminal device is in an RRC_IDLE or RRC_INACTIVE state). Alternatively, a set of candidate AS configurations can be configured by a network device via dedicated signaling or SIB, or can be predefined in the first terminal device (and the second terminal device). In this case, the first terminal device can autonomously select one of the candidate AS configurations in the set based on e.g., its capability, configuration and/or network condition.

At block 420, a second message (referred to as e.g., RRCReconfigurationFailureSidelink) indicating a failure of the first sidelink AS configuration is received from the second terminal device, e.g., via RRC signaling over a PC5 link. The failure of the first sidelink AS configuration means that the second terminal device is not able to comply with at least one of the configuration parameters in the first sidelink AS configuration, depending on its capability, configuration and/or network condition.

At block 430, a report regarding the failure of the first sidelink AS configuration is transmitted to a network device (e.g., a gNB), e.g., via RRC signaling over a Uu interface. The report may be transmitted using a new RRC signaling message (referred to as e.g., FailureInformation) or an existing RRC signaling message (e.g., SidelinkUEInformation). The report may be transmitted after a predetermined number of sidelink AS configuration failures between the first and second terminal devices. The report may indicate one or more configuration parameters (which may include an SLRB configuration parameter) the second terminal device is not able to comply with in the first sidelink AS configuration. In an example, the report contains one or more of:
an indicator indicating the failure of the first sidelink AS configuration, which can be e.g., a one-bit indicator indicating the failure when set to 1;
or
an identification of the second terminal device, e.g., a source L2 ID or a destination L2 ID of a PC5 unicast link.

In an example, the report may further contain one or more of:
an indication of a specific failure type, e.g., an SLRB configuration failure, which can be indicated in, or derived from, the second message;
an indication of the one or more configuration parameters the second terminal device is not able to comply with (or one or more configuration parameters the second terminal device is able to comply with);
an identification of the first terminal device, e.g., a source L2 ID or a destination L2 ID of a PC5 unicast link;
an identification of an SLRB, e.g., an SLRB ID, associated with the failure;
or
an indication of all configuration parameters in the first sidelink AS configuration, with indication of the one or more configuration parameters the second terminal device is not able to comply with (or one or more configuration parameters the second terminal device is able to comply with).

In an example, the first terminal device may transmit a third message (e.g., a new RRCReconfigurationSidelink) indicating a second sidelink AS configuration to the second terminal device in response to the second message.

Here, the second sidelink AS configuration may contain a full sidelink AS configuration (i.e., including a full set of information elements or fields) or a difference from the first sidelink AS configuration.

In an example, the second message may further indicate one or more configuration parameters that the second terminal device is not able to comply with in the first sidelink AS configuration. In an example, the one or more configuration parameters may include an SLRB configuration parameter. For example, the second message may contain all the configuration parameters in the first sidelink AS configuration and identify which of these configuration parameters the second terminal device is not able to comply with. Accordingly, the first terminal device can determine the second sidelink AS configuration based on the one or more configuration parameters. For example, the second sidelink AS configuration can be determined in such a manner that the one or more configuration parameters are changed when compared with the first sidelink AS configuration. As an alternative, the second message may indicate one or more configuration parameters that the second terminal device is able to comply with in the first sidelink AS configuration.

In another example, the second message may further include capability information of the second terminal device. Accordingly, the second sidelink AS configuration can be determined based on the capability information. For example, the second sidelink AS configuration can be determined in such a manner that the one or more configuration parameters can be replaced with one or more configuration parameters determined, based on the capability information, to be supported by the second terminal device.

Alternatively, when a set of candidate AS configurations has been configured or predefined in the first and second terminal devices as described above, the second message may further indicate at least one candidate sidelink AS configuration that the second terminal device is able to comply with. In this case, the second sidelink AS configuration can be selected, e.g., autonomously by the first terminal device, from the at least one candidate sidelink AS configuration.

In an example, the first terminal device may receive from the network device a fourth message (referred to as e.g., RRCReconfiguration) indicating the second sidelink AS configuration, as a response to the report, and can then signal the second sidelink AS configuration to the second terminal device.

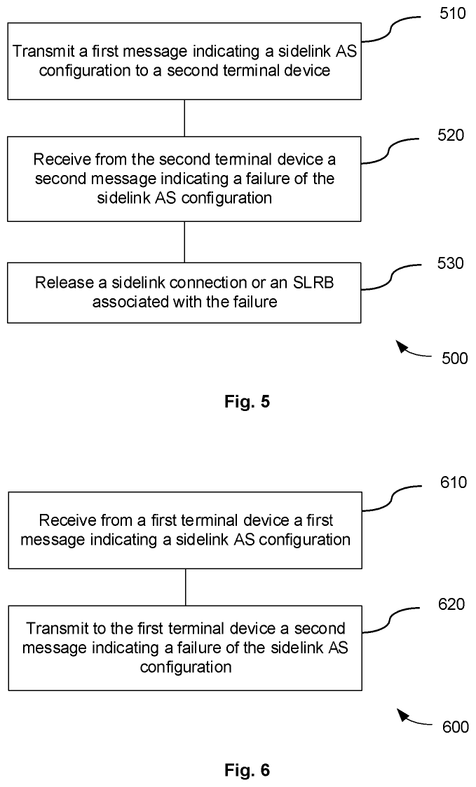

FIG. 5 is a flowchart illustrating a method 500 according to an embodiment of the present disclosure. The method 500 can be performed at a first terminal device, e.g., UE 1 in FIG. 3.

At block 510, a first message (e.g., RRCReconfigurationSidelink) indicating a sidelink AS configuration is transmitted to a second terminal device (e.g., UE 2 in FIG. 3). For further details of the first message in the block 510, reference can be made to the first message described above in connection with the method 400.

At block 520, a second message (e.g., RRCReconfigurationFailureSidelink) indicating a failure of the sidelink AS configuration is received from the second terminal device. For further details of the second message in the block 520, reference can be made to the second message described above in connection with the method 400.

At block 530, a sidelink connection or an SLRB associated with the failure is released.

In an example, in the block 530, the sidelink connection or the SLRB may be released in response to determining that no other sidelink AS configuration is usable for the sidelink connection or the SLRB.

For example, the second message may further indicate one or more configuration parameters that the second terminal device is not able to comply with in the sidelink AS configuration. The one or more configuration parameters may include an SLRB configuration parameter. In this case, the first terminal device can determine based on the one or more configuration parameters that no other sidelink AS configuration is usable for the sidelink connection or the SLRB. For example, the sidelink connection may include a set of SLRBs. If the second message indicates that the second terminal device is not able to comply with an SLRB configuration parameter associated with a particular SLRB only, the particular SLRB, instead of the entire sidelink connection, can be released in the block 530.

Alternatively, the second message may further indicate at least one candidate sidelink AS configuration that the second terminal device is able to comply with. In this case, the first terminal device can determine based on the at least one candidate sidelink AS configuration that no other sidelink AS configuration is usable for the sidelink connection or the SLRB, e.g., when the first terminal device is not able to comply with any of the at least one candidate sidelink AS configuration.

In an example, the first terminal device may transmit to a network device (e.g., a gNB) a notification that the sidelink connection or the SLRB has been released. The notification may also indicate a cause of the release as sidelink AS configuration failure. The notification can be transmitted via RRC signaling over a Uu interface, using e.g., FailureInformation or SidelinkUEInformation as described above.

Alternatively, the first terminal device may transmit to a network device (e.g., a gNB) a report regarding the failure of the sidelink AS configuration, e.g., via RRC signaling over a Uu interface. The report may be transmitted using a new RRC signaling message (e.g., FailureInformation) or an existing RRC signaling message (e.g., SidelinkUEInformation). The report may be transmitted after a predetermined number of sidelink AS configuration failures between the first and second terminal devices. The report may indicate the one or more configuration parameters (which may include an SLRB configuration parameter) the second terminal device is not able to comply with. The report may contain one or more of: an indicator indicating the failure of the sidelink AS configuration, an identification of the first terminal device and an identification of the second terminal device, or an identification of the SLRB (for further details, reference can be made to the report described above in connection with the method 400). Then, the first terminal device can receive from the network device an indication that no other sidelink AS configuration is usable for the sidelink connection or the SLRB. In this case, in the block 530, the first terminal device can release the sidelink connection or SLRB in response to receiving the indication.

FIG. 6 is a flowchart illustrating a method 600 according to an embodiment of the present disclosure. The method 600 can be performed at a second terminal device, e.g., UE 2 in FIG. 3.

At block 610, a first message (e.g., RRCReconfigurationSidelink) indicating a sidelink AS configuration is received from a first terminal device (e.g., UE 1 in FIG. 3), e.g., via RRC signaling over a PC5 interface. For further details of the first message in the block 610, reference can be made to the first message described above in connection with the method 400.

At block 620, a second message (e.g., RRCReconfigurationFailureSidelink) indicating a failure of the sidelink AS configuration is transmitted to the first terminal device, e.g., via RRC signaling over a PC5 interface. The second message may further indicate one or more configuration parameters that the second terminal device is not able to comply with in the sidelink AS configuration. The one or more configuration parameters may include an SLRB configuration parameter. Alternatively, the second message may further indicate at least one candidate sidelink AS configuration that the second terminal device is able to comply with. In another example, the second message may further include capability information of the second terminal device. For further details of the second message in the block 620, reference can be made to the second message described above in connection with the method 400.

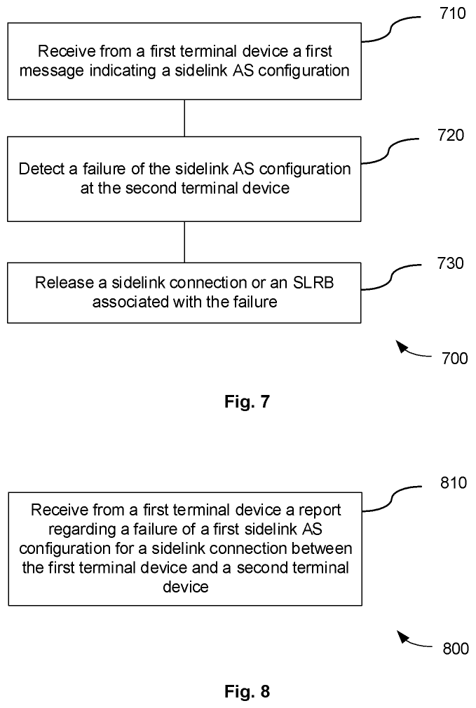

FIG. 7 is a flowchart illustrating a method 700 according to an embodiment of the present disclosure. The method 700 can be performed at a second terminal device, e.g., UE 2 in FIG. 3.

At block 710, a first message (e.g., RRCReconfigurationSidelink) indicating a sidelink AS configuration is received from a first terminal device (e.g., UE 1 in FIG. 3), e.g., via RRC signaling over a PC5 interface. For further details of the first message in the block 710, reference can be made to the first message described above in connection with the method 400.

At block 720, a failure of the sidelink AS configuration is detected at the second terminal device. For example, in the block 720, the second terminal device may determine that it is not able to comply with at least one of the configuration parameters in the sidelink AS configuration, depending on its capability, configuration and/or network condition.

At block 730, a sidelink connection or an SLRB associated with the failure is released. For example, the sidelink connection may include a set of SLRBs. If the second terminal device is not able to comply with an SLRB configuration parameter associated with a particular SLRB only in the sidelink AS configuration, the particular SLRB, instead of the entire sidelink connection, can be released in the block 730.

In an example, the second terminal device can transmit to the first terminal device a second message (e.g., RRCReconfigurationFailureSidelink) indicating that the sidelink connection or the SLRB has been released, e.g., via RRC signaling over a PC5 interface.

FIG. 8 is a flowchart illustrating a method 800 according to an embodiment of the present disclosure. The method 800 can be performed at a network device, e.g., a gNB serving UE1 in FIG. 3.

At block 810, a report regarding a failure of a first sidelink AS configuration for a sidelink connection between a first terminal device (e.g., UE 1 in FIG. 3) and a second terminal device (e.g., UE 2 in FIG. 3) is received from the first terminal device, e.g., via RRC signaling over a Uu interface. The report may use a new RRC signaling message (e.g., FailureInformation) or an existing RRC signaling message (e.g., SidelinkUEInformation). The report contains one or more of: an indicator indicating the failure of the sidelink AS configuration, or an identification of the second terminal device.

The report may further contain one or more of: an identification of the first terminal device, or an identification of the SLRB (for further details, reference can be made to the report described above in connection with the method 400).

In an example, the second terminal device can transmit a message (e.g., RRCReconfiguration) indicating a second sidelink AS configuration for the sidelink connection to the first terminal device.

In an example, the second sidelink AS configuration may contain a full sidelink AS configuration or a difference from the first sidelink AS configuration.

In an example, the report may indicate one or more configuration parameters (which may include an SLRB configuration parameter) the second terminal device is not able to comply with in the first sidelink AS configuration. The second sidelink AS configuration can be determined by the network device based on the one or more configuration parameters. As an alternative, the report may indicate one or more configuration parameters that the second terminal device is able to comply with in the first sidelink AS configuration.

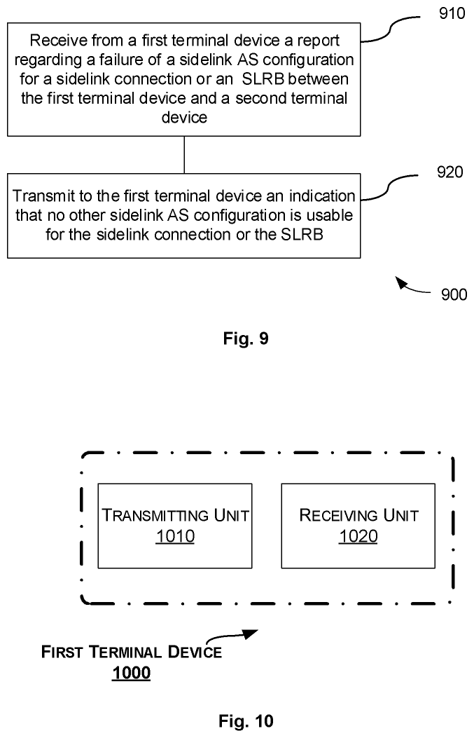

FIG. 9 is a flowchart illustrating a method 900 according to an embodiment of the present disclosure. The method 900 can be performed at a network device, e.g., a gNB serving UE1 in FIG. 3.

At block 910, a report regarding a failure of a sidelink AS configuration for a sidelink connection between a first terminal device (e.g., UE 1 in FIG. 3) and a second terminal device (e.g., UE 2 in FIG. 3) is received from the first terminal device, e.g., via RRC signaling over a Uu interface. The report may use a new RRC signaling message (e.g., FailureInformation) or an existing RRC signaling message (e.g., SidelinkUEInformation).

At block 920, an indication that no other sidelink AS configuration is usable for the sidelink connection or the SLRB is transmitted to the first terminal device.

In an example, the report may indicate the one or more configuration parameters (which may include an SLRB configuration parameter) the second terminal device is not able to comply with in the sidelink AS configuration. The network device can determine based on the one or more configuration parameters that no other sidelink AS configuration is usable for the sidelink connection or the SLRB.

The report may contain one or more of: an indicator indicating the failure of the sidelink AS configuration, an identification of the first terminal device and an identification of the second terminal device, or an identification of the SLRB (for further details, reference can be made to the report described above in connection with the method 400).

In an example, the network device can receive from the first terminal device a notification that the sidelink connection or the SLRB has been released.

Correspondingly to the method 400 as described above, a first terminal device is provided. FIG. 10 is a block diagram of a first terminal device 1000 according to an embodiment of the present disclosure.

As shown in FIG. 10, the first terminal device 1000 includes a transmitting unit 1010 configured to transmit a first message indicating a first sidelink AS configuration to a second terminal device. The first terminal device 1000 further includes a receiving unit 1020 configured to receive from the second terminal device a second message indicating a failure of the first sidelink AS configuration. The transmitting unit 1010 is further configured to transmit to a network device a report regarding the failure of the first sidelink AS configuration. The report contains one or more of: an indicator indicating the failure of the first sidelink AS configuration, or an identification of the second terminal device.

In an embodiment, the second message may further indicate one or more configuration parameters that the second terminal device is not able to comply with in the first sidelink AS configuration, and the report may contain the one or more configuration parameters.

In an embodiment, the one or more configuration parameters may include an SLRB configuration parameter.

In an embodiment, the report may further contain one or more of: an identification of the first terminal device; or an identification of an SLRB associated with the failure.

In an embodiment, the transmitting unit 1010 can be further configured to transmit to the second terminal device a third message indicating a second sidelink AS configuration in response to the second message.

In an embodiment, the second sidelink AS configuration may contain a full sidelink AS configuration or a difference from the first sidelink AS configuration.

In an embodiment, the second message may further indicate one or more configuration parameters that the second terminal device is not able to comply with in the first sidelink AS configuration, and the second sidelink AS configuration may be determined based on the one or more configuration parameters.

In an embodiment, the one or more configuration parameters may include an SLRB configuration parameter.

In an embodiment, the second message may further indicate at least one candidate sidelink AS configuration that the second terminal device is able to comply with, and the second sidelink AS configuration may be selected from the at least one candidate sidelink AS configuration.

In an embodiment, the receiving unit 1020 can be further configured to receive a fourth message indicating the second sidelink AS configuration from the network device.

The units 1010 and 1020 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4.

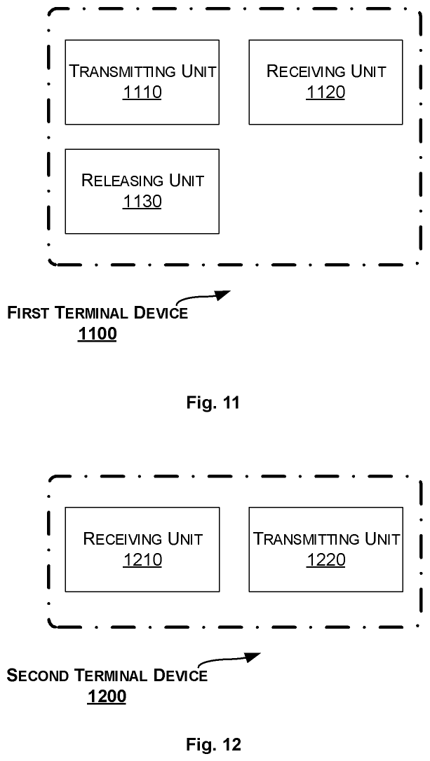

Correspondingly to the method 500 as described above, a first terminal device is provided. FIG. 11 is a block diagram of a first terminal device 1100 according to another embodiment of the present disclosure.

As shown in FIG. 11, the first terminal device 1100 includes a transmitting unit 1110 configured to transmit first message indicating a sidelink AS configuration to a second terminal device. The first terminal device 1100 includes a receiving unit 1120 configured to receive from the second terminal device a second message indicating a failure of the sidelink AS configuration. The first terminal device 1100 further includes a releasing unit 1130 configured to release a sidelink connection or an SLRB associated with the failure.

In an embodiment, the sidelink connection or the SLRB may be released in response to determining that no other sidelink AS configuration is usable for the sidelink connection or the SLRB.

In an embodiment, the second message may further indicate one or more configuration parameters that the second terminal device is not able to comply with in the sidelink AS configuration. It can be determined based on the one or more configuration parameters that no other sidelink AS configuration is usable for the sidelink connection or the SLRB.

In an embodiment, the one or more configuration parameters may include an SLRB configuration parameter.

In an embodiment, the second message may further indicate at least one candidate sidelink AS configuration that the second terminal device is able to comply with. It can be determined based on the at least one candidate sidelink AS configuration that no other sidelink AS configuration is usable for the sidelink connection or the SLRB.

In an embodiment, the transmitting unit 1110 can be further configured to transmit to a network device a notification that the sidelink connection or the SLRB has been released.

In an embodiment, the transmitting unit 1110 can be further configured to transmit to a network device a report regarding the failure of the sidelink AS configuration. The receiving unit 1120 can be further configured to receive from the network device an indication that no other sidelink AS configuration is usable for the sidelink connection or the SLRB. The sidelink connection or the SLRB may be released in response to receiving the indication.

In an embodiment, the second message may further indicate one or more configuration parameters that the second terminal device is not able to comply with in the sidelink AS configuration. The report may contain the one or more configuration parameters.

In an embodiment, the one or more configuration parameters may include an SLRB configuration parameter.

In an embodiment, the report may contain one or more of: an indicator indicating the failure of the sidelink AS configuration, an identification of the first terminal device and an identification of the second terminal device, or an identification of the SLRB.

The units 1110˜1130 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

Correspondingly to the method 600 as described above, a second terminal device is provided. FIG. 12 is a block diagram of a second terminal device 1200 according to an embodiment of the present disclosure.

As shown in FIG. 12, the second terminal device 1200 includes a receiving unit 1210 configured to receive from a first terminal device a first message indicating a sidelink AS configuration. The second terminal device 1200 further includes a transmitting unit 1220 configured to transmit to the first terminal device a second message indicating a failure of the sidelink AS configuration. The second message further indicates one or more configuration parameters that the second terminal device is not able to comply with in the sidelink AS configuration, or at least one candidate sidelink AS configuration that the second terminal device is able to comply with.

In an embodiment, the one or more configuration parameters may include an SLRB configuration parameter.

The units 1210 and 1220 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6.

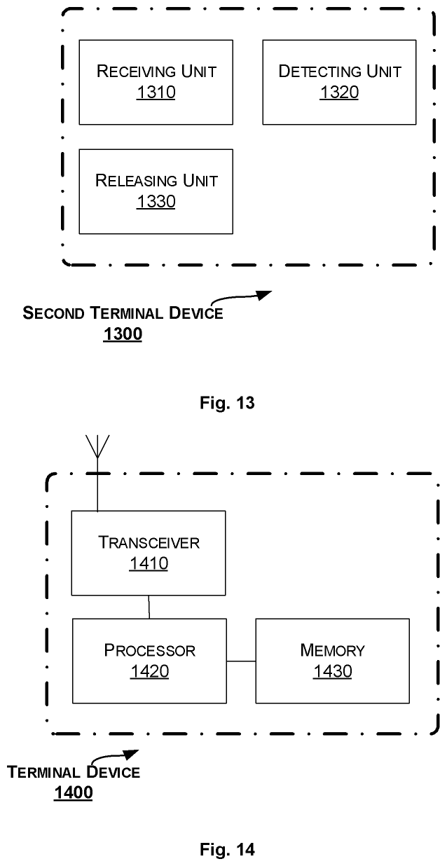

Correspondingly to the method 700 as described above, a second terminal device is provided. FIG. 13 is a block diagram of a second terminal device 1300 according to another embodiment of the present disclosure.

As shown in FIG. 13, the second terminal device 1300 includes a receiving unit 1310 configured to receive from a first terminal device a first message indicating a sidelink AS configuration. The second terminal device 1300 further includes a detecting unit 1320 configured to detect a failure of the sidelink AS configuration at the second terminal device. The second terminal device 1300 further includes a releasing unit 1330 configured to release a sidelink connection or an SLRB associated with the failure.

In an embodiment, the second terminal device 1300 may further include a transmitting unit configured to transmit to the first terminal device a second message indicating that the sidelink connection or the SLRB has been released.

The units 1310˜1330 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7.

FIG. 14 is a block diagram of a terminal device 1400 according to another embodiment of the present disclosure.

The terminal device 1400 includes a transceiver 1410, a processor 1420 and a memory 1430. The memory 1430 may contain instructions executable by the processor 1420 whereby the terminal device 1400 is operative to perform, as a first terminal device, the actions, e.g., of the procedure described earlier in conjunction with FIG. 4. Particularly, the memory 1430 contains instructions executable by the processor 1420 whereby the terminal device 1400 is operative to, as a first terminal device: transmit a first message indicating a first sidelink AS configuration to a second terminal device; receive from the second terminal device a second message indicating a failure of the first sidelink AS configuration; and transmit to a network device a report regarding the failure of the first sidelink AS configuration. The report contains one or more of: an indicator indicating the failure of the first sidelink AS configuration, or an identification of the second terminal device.

In an embodiment, the second message may further indicate one or more configuration parameters that the second terminal device is not able to comply with in the first sidelink AS configuration, and the report may contain the one or more configuration parameters.

In an embodiment, the one or more configuration parameters may include an SLRB configuration parameter.

In an embodiment, the report may further contain one or more of: an identification of the first terminal device; or an identification of an SLRB associated with the failure.

In an embodiment, the memory 1430 may further contain instructions executable by the processor 1420 whereby the terminal device 1400 is operative to: transmit to the second terminal device a third message indicating a second sidelink AS configuration in response to the second message.

In an embodiment, the second sidelink AS configuration may contain a full sidelink AS configuration or a difference from the first sidelink AS configuration.

In an embodiment, the second message may further indicate one or more configuration parameters that the second terminal device is not able to comply with in the first sidelink AS configuration, and the second sidelink AS configuration may be determined based on the one or more configuration parameters.

In an embodiment, the one or more configuration parameters may include an SLRB configuration parameter.

In an embodiment, the second message may further indicate at least one candidate sidelink AS configuration that the second terminal device is able to comply with, and the second sidelink AS configuration may be selected from the at least one candidate sidelink AS configuration.

In an embodiment, the memory 1430 may further contain instructions executable by the processor 1420 whereby the terminal device 1400 is operative to: receive a fourth message indicating the second sidelink AS configuration from the network device.

Alternatively, the memory 1430 may contain instructions executable by the processor 1420 whereby the terminal device 1400 is operative to perform, as a first terminal device, the actions, e.g., of the procedure described earlier in conjunction with FIG. 5. Particularly, the memory 1430 contains instructions executable by the processor 1420 whereby the terminal device 1400 is operative to, as a first terminal device: transmit a first message indicating a sidelink AS configuration to a second terminal device; receive from the second terminal device a second message indicating a failure of the sidelink AS configuration; and release a sidelink connection or an SLRB associated with the failure.

In an embodiment, the sidelink connection or the SLRB may be released in response to determining that no other sidelink AS configuration is usable for the sidelink connection or the SLRB.

In an embodiment, the second message may further indicate one or more configuration parameters that the second terminal device is not able to comply with in the sidelink AS configuration. It can be determined based on the one or more configuration parameters that no other sidelink AS configuration is usable for the sidelink connection or the SLRB.

In an embodiment, the one or more configuration parameters may include an SLRB configuration parameter.

In an embodiment, the second message may further indicate at least one candidate sidelink AS configuration that the second terminal device is able to comply with. It can be determined based on the at least one candidate sidelink AS configuration that no other sidelink AS configuration is usable for the sidelink connection or the SLRB.

In an embodiment, the memory 1430 may further contain instructions executable by the processor 1420 whereby the terminal device 1400 is operative to: transmit to a network device a notification that the sidelink connection or the SLRB has been released.

In an embodiment, the memory 1430 may further contain instructions executable by the processor 1420 whereby the terminal device 1400 is operative to: transmit to a network device a report regarding the failure of the sidelink AS configuration; and receive from the network device an indication that no other sidelink AS configuration is usable for the sidelink connection or the SLRB. The sidelink connection or the SLRB may be released in response to receiving the indication.

In an embodiment, the second message may further indicate one or more configuration parameters that the second terminal device is not able to comply with in the sidelink AS configuration. The report may contain the one or more configuration parameters.

In an embodiment, the one or more configuration parameters may include an SLRB configuration parameter.

In an embodiment, the report may contain one or more of: an indicator indicating the failure of the sidelink AS configuration, an identification of the first terminal device and an identification of the second terminal device, or an identification of the SLRB.

Alternatively, the memory 1430 may contain instructions executable by the processor 1420 whereby the terminal device 1400 is operative to perform, as a second terminal device, the actions, e.g., of the procedure described earlier in conjunction with FIG. 6. Particularly, the memory 1430 contains instructions executable by the processor 1420 whereby the terminal device 1400 is operative to, as a second terminal device: receive from a first terminal device a first message indicating a sidelink AS configuration; and transmit to the first terminal device a second message indicating a failure of the sidelink AS configuration. The second message further indicates one or more configuration parameters that the second terminal device is not able to comply with in the sidelink AS configuration, or at least one candidate sidelink AS configuration that the second terminal device is able to comply with.

In an embodiment, the one or more configuration parameters may include an SLRB configuration parameter.

Alternatively, the memory 1430 may contain instructions executable by the processor 1420 whereby the terminal device 1400 is operative to perform, as a second terminal device, the actions, e.g., of the procedure described earlier in conjunction with FIG. 7. Particularly, the memory 1430 contains instructions executable by the processor 1420 whereby the terminal device 1400 is operative to, as a second terminal device: receive from a first terminal device a first message indicating a sidelink AS configuration; detect a failure of the sidelink AS configuration at the second terminal device; and release a sidelink connection or an SLRB associated with the failure.

In an embodiment, the memory 1430 may further contain instructions executable by the processor 1420 whereby the terminal device 1400 is operative to: transmit to the first terminal device a second message indicating that the sidelink connection or the SLRB has been released.

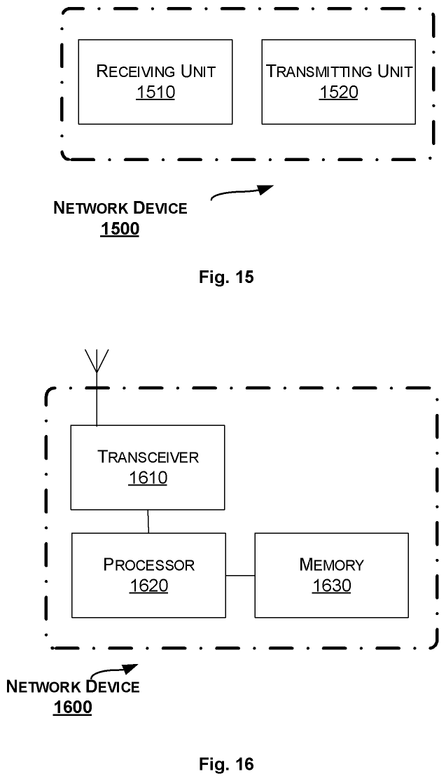

Correspondingly to the method 800 or 900 as described above, a network device is provided. FIG. 15 is a block diagram of a network device 1500 according to an embodiment of the present disclosure.

The network device 1500 can be configured to perform the method 800 as shown in FIG. 8. The network device 1500 includes a receiving unit 1510 configured to receive from a first terminal device a report regarding a failure of a first sidelink AS configuration for a sidelink connection between the first terminal device and a second terminal device. The report contains one or more of: an indicator indicating the failure of the first sidelink AS configuration, or an identification of the second terminal device.

In an embodiment, the report may further contain one or more of: an identification of the first terminal device, or an identification of an SLRB associated with the failure.

In an embodiment, the network device 1500 may further include a transmitting unit 1520 configured to transmit to the first terminal device a message indicating a second sidelink AS configuration for the sidelink connection.

In an embodiment, the second sidelink AS configuration may contain a full sidelink AS configuration or a difference from the first sidelink AS configuration.

In an embodiment, the report may further indicate one or more configuration parameters that the second terminal device is not able to comply with in the first sidelink AS configuration, and the second sidelink AS configuration may be determined based on the one or more configuration parameters.

In an embodiment, the one or more configuration parameters may include an SLRB configuration parameter.

Alternatively, the network device 1500 can be configured to perform the method 900 as shown in FIG. 9. The network device 1500 includes a receiving unit 1510 configured to receive from a first terminal device a report regarding a failure of a sidelink AS configuration for a sidelink connection or an SLRB between the first terminal device and a second terminal device. The network device 1500 further includes a transmitting unit 1520 configured to transmit to the first terminal device an indication that no other sidelink AS configuration is usable for the sidelink connection or the SLRB.

In an embodiment, the report may further indicate one or more configuration parameters that the second terminal device is not able to comply with in the sidelink AS configuration. The network device 1500 may further include: a determining unit configured to determine that no other sidelink AS configuration is usable for the sidelink connection or the SLRB based on the one or more configuration parameters.

In an embodiment, the one or more configuration parameters may include an SLRB configuration parameter.

In an embodiment, the report may contain one or more of: an indicator indicating the failure of the sidelink AS configuration, an identification of the first terminal device and an identification of the second terminal device, or an identification of the SLRB.

In an embodiment, the receiving unit 1510 can be further configured to receive from the first terminal device a notification that the sidelink connection or the SLRB has been released.

The units 1510 and 1520 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8 or 9.

FIG. 16 is a block diagram of a network device 1600 according to another embodiment of the present disclosure.

The network device 1600 includes a transceiver 1610, a processor 1620 and a memory 1630. The memory 1630 may contain instructions executable by the processor 1620 whereby the network device 1600 is operative to perform the actions, e.g., of the procedure described earlier in conjunction with FIG. 8. Particularly, the memory 1630 contains instructions executable by the processor 1620 whereby the network device 1600 is operative to: receive from a first terminal device a report regarding a failure of a first sidelink AS configuration for a sidelink connection between the first terminal device and a second terminal device. The report contains one or more of: an indicator indicating the failure of the first sidelink AS configuration, or an identification of the second terminal device.

In an embodiment, the report may further contain one or more of: an identification of the first terminal device, or an identification of an SLRB associated with the failure.

In an embodiment, the memory 1630 may further contain instructions executable by the processor 1620 whereby the network device 1600 is operative to: transmit to the first terminal device a message indicating a second sidelink AS configuration for the sidelink connection.

In an embodiment, the second sidelink AS configuration may contain a full sidelink AS configuration or a difference from the first sidelink AS configuration.

In an embodiment, the report may further indicate one or more configuration parameters that the second terminal device is not able to comply with in the first sidelink AS configuration, and the second sidelink AS configuration may be determined based on the one or more configuration parameters.

In an embodiment, the one or more configuration parameters may include an SLRB configuration parameter.

Alternatively, the memory 1630 may contain instructions executable by the processor 1620 whereby the network device 1600 is operative to perform the actions, e.g., of the procedure described earlier in conjunction with FIG. 9. Particularly, the memory 1630 contains instructions executable by the processor 1620 whereby the network device 1600 is operative to: receive from a first terminal device a report regarding a failure of a sidelink AS configuration for a sidelink connection or an SLRB between the first terminal device and a second terminal device; and transmit to the first terminal device an indication that no other sidelink AS configuration is usable for the sidelink connection or the SLRB.

In an embodiment, the report may further indicate one or more configuration parameters that the second terminal device is not able to comply with in the sidelink AS configuration. The memory 1630 may further contain instructions executable by the processor 1620 whereby the network device 1600 is operative to: determine that no other sidelink AS configuration is usable for the sidelink connection or the SLRB based on the one or more configuration parameters.

In an embodiment, the one or more configuration parameters may include an SLRB configuration parameter.

In an embodiment, the report may contain one or more of: an indicator indicating the failure of the sidelink AS configuration, an identification of the first terminal device and an identification of the second terminal device, or an identification of the SLRB.

In an embodiment, the memory 1630 may further contain instructions executable by the processor 1620 whereby the network device 1600 is operative to: receive from the first terminal device a notification that the sidelink connection or the SLRB has been released.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1420 causes the terminal device 1400 to perform the actions, e.g., of the procedure described earlier in conjunction with FIG. 4, 5, 6, or 7; or code/computer readable instructions, which when executed by the processor 1620 causes the network device 1600 to perform the actions, e.g., of the procedure described earlier in conjunction with FIG. 8 or 9.

The computer program product may be configured as a computer program code structured in computer program modules. The computer program modules could essentially perform the actions of the flow illustrated in FIG. 4, 5, 6, 7, 8, or 9.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

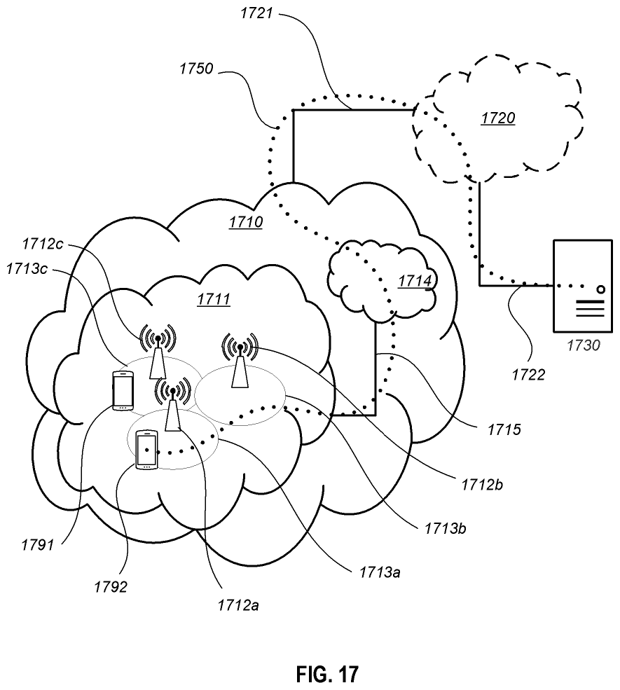

With reference to FIG. 17, in accordance with an embodiment, a communication system includes a telecommunication network 1710, such as a 3GPP-type cellular network, which comprises an access network 1711, such as a radio access network, and a core network 1714. The access network 1711 comprises a plurality of base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to the core network 1714 over a wired or wireless connection 1715. A first user equipment (UE) 1791 located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712.

The telecommunication network 1710 is itself connected to a host computer 1730, which may be embodied in the hardware and/or software of a standalone server, a cloud-implemented server, a distributed server or as processing resources in a server farm. The host computer 1730 may be under the ownership or control of a service provider, or may be operated by the service provider or on behalf of the service provider. The connections 1721, 1722 between the telecommunication network 1710 and the host computer 1730 may extend directly from the core network 1714 to the host computer 1730 or may go via an optional intermediate network 1720. The intermediate network 1720 may be one of, or a combination of more than one of, a public, private or hosted network; the intermediate network 1720, if any, may be a backbone network or the Internet; in particular, the intermediate network 1720 may comprise two or more sub-networks (not shown).

The communication system of FIG. 17 as a whole enables connectivity between one of the connected UEs 1791, 1792 and the host computer 1730. The connectivity may be described as an over-the-top (OTT) connection 1750. The host computer 1730 and the connected UEs 1791, 1792 are configured to communicate data and/or signaling via the OTT connection 1750, using the access network 1711, the core network 1714, any intermediate network 1720 and possible further infrastructure (not shown) as intermediaries. The OTT connection 1750 may be transparent in the sense that the participating communication devices through which the OTT connection 1750 passes are unaware of routing of uplink and downlink communications. For example, a base station 1712 may not or need not be informed about the past routing of an incoming downlink communication with data originating from a host computer 1730 to be forwarded (e.g., handed over) to a connected UE 1791. Similarly, the base station 1712 need not be aware of the future routing of an outgoing uplink communication originating from the UE 1791 towards the host computer 1730.

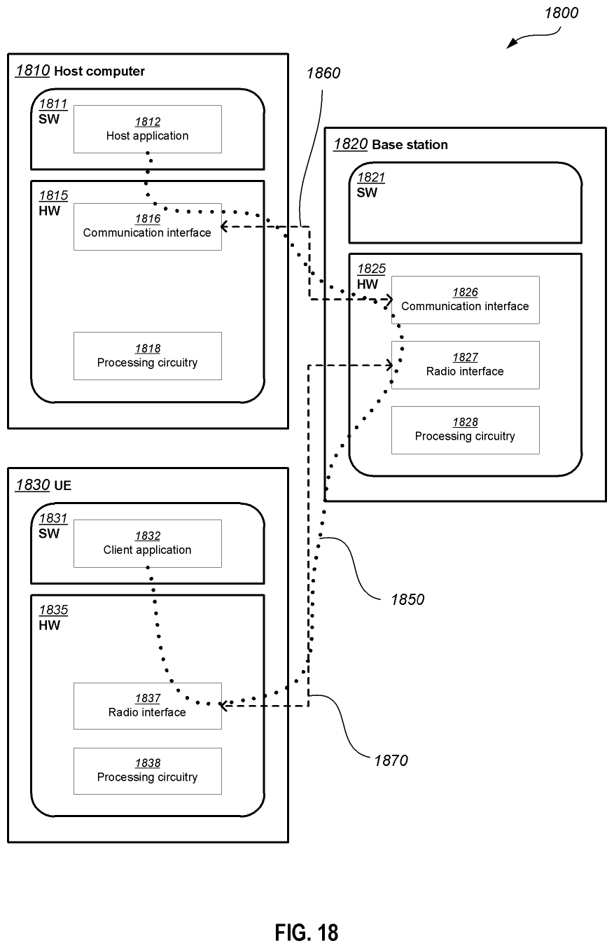

Example implementations, in accordance with an embodiment, of the UE, base station and host computer discussed in the preceding paragraphs will now be described with reference to FIG. 18. In a communication system 1800, a host computer 1810 comprises hardware 1815 including a communication interface 1816 configured to set up and maintain a wired or wireless connection with an interface of a different communication device of the communication system 1800. The host computer 1810 further comprises processing circuitry 1818, which may have storage and/or processing capabilities. In particular, the processing circuitry 1818 may comprise one or more programmable processors, application-specific integrated circuits, field programmable gate arrays or combinations of these (not shown) adapted to execute instructions. The host computer 1810 further comprises software 1811, which is stored in or accessible by the host computer 1810 and executable by the processing circuitry 1818. The software 1811 includes a host application 1812. The host application 1812 may be operable to provide a service to a remote user, such as a UE 1830 connecting via an OTT connection 1850 terminating at the UE 1830 and the host computer 1810. In providing the service to the remote user, the host application 1812 may provide user data which is transmitted using the OTT connection 1850.

The communication system 1800 further includes a base station 1820 provided in a telecommunication system and comprising hardware 1825 enabling it to communicate with the host computer 1810 and with the UE 1830. The hardware 1825 may include a communication interface 1826 for setting up and maintaining a wired or wireless connection with an interface of a different communication device of the communication system 1800, as well as a radio interface 1827 for setting up and maintaining at least a wireless connection 1870 with a UE 1830 located in a coverage area (not shown in FIG. 18) served by the base station 1820. The communication interface 1826 may be configured to facilitate a connection 1860 to the host computer 1810. The connection 1860 may be direct or it may pass through a core network (not shown in FIG. 18) of the telecommunication system and/or through one or more intermediate networks outside the telecommunication system. In the embodiment shown, the hardware 1825 of the base station 1820 further includes processing circuitry 1828, which may comprise one or more programmable processors, application-specific integrated circuits, field programmable gate arrays or combinations of these (not shown) adapted to execute instructions. The base station 1820 further has software 1821 stored internally or accessible via an external connection.

The communication system 1800 further includes the UE 1830 already referred to. Its hardware 1835 may include a radio interface 1837 configured to set up and maintain a wireless connection 1870 with a base station serving a coverage area in which the UE 1830 is currently located. The hardware 1835 of the UE 1830 further includes processing circuitry 1838, which may comprise one or more programmable processors, application-specific integrated circuits, field programmable gate arrays or combinations of these (not shown) adapted to execute instructions. The UE 1830 further comprises software 1831, which is stored in or accessible by the UE 1830 and executable by the processing circuitry 1838. The software 1831 includes a client application 1832. The client application 1832 may be operable to provide a service to a human or non-human user via the UE 1830, with the support of the host computer 1810. In the host computer 1810, an executing host application 1812 may communicate with the executing client application 1832 via the OTT connection 1850 terminating at the UE 1830 and the host computer 1810. In providing the service to the user, the client application 1832 may receive request data from the host application 1812 and provide user data in response to the request data. The OTT connection 1850 may transfer both the request data and the user data. The client application 1832 may interact with the user to generate the user data that it provides.

It is noted that the host computer 1810, base station 1820 and UE 1830 illustrated in FIG. 18 may be identical to the host computer 1730, one of the base stations 1712a, 1712b, 1712c and one of the UEs 1791, 1792 of FIG. 17, respectively. This is to say, the inner workings of these entities may be as shown in FIG. 18 and independently, the surrounding network topology may be that of FIG. 17.

In FIG. 18, the OTT connection 1850 has been drawn abstractly to illustrate the communication between the host computer 1810 and the use equipment 1830 via the base station 1820, without explicit reference to any intermediary devices and the precise routing of messages via these devices. Network infrastructure may determine the routing, which it may be configured to hide from the UE 1830 or from the service provider operating the host computer 1810, or both. While the OTT connection 1850 is active, the network infrastructure may further take decisions by which it dynamically changes the routing (e.g., on the basis of load balancing consideration or reconfiguration of the network).

The wireless connection 1870 between the UE 1830 and the base station 1820 is in accordance with the teachings of the embodiments described throughout this disclosure. One or more of the various embodiments improve the performance of OTT services provided to the UE 1830 using the OTT connection 1850, in which the wireless connection 1870 forms the last segment. More precisely, the teachings of these embodiments may improve the data rate and latency and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1850 between the host computer 1810 and UE 1830, in response to variations in the measurement results. The measurement procedure and/or the network functionality for reconfiguring the OTT connection 1850 may be implemented in the software 1811 of the host computer 1810 or in the software 1831 of the UE 1830, or both. In embodiments, sensors (not shown) may be deployed in or in association with communication devices through which the OTT connection 1850 passes; the sensors may participate in the measurement procedure by supplying values of the monitored quantities exemplified above, or supplying values of other physical quantities from which software 1811, 1831 may compute or estimate the monitored quantities. The reconfiguring of the OTT connection 1850 may include message format, retransmission settings, preferred routing etc.; the reconfiguring need not affect the base station 1820, and it may be unknown or imperceptible to the base station 1820. Such procedures and functionalities may be known and practiced in the art. In certain embodiments, measurements may involve proprietary UE signaling facilitating the host computer's 1810 measurements of throughput, propagation times, latency and the like. The measurements may be implemented in that the software 1811, 1831 causes messages to be transmitted, in particular empty or ‘dummy’ messages, using the OTT connection 1850 while it monitors propagation times, errors etc.

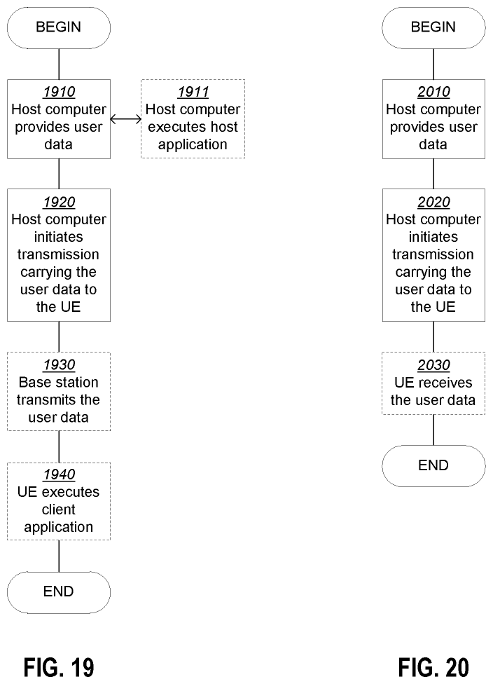

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section. In a first step 1910 of the method, the host computer provides user data. In an optional substep 1911 of the first step 1910, the host computer provides the user data by executing a host application. In a second step 1920, the host computer initiates a transmission carrying the user data to the UE. In an optional third step 1930, the base station transmits to the UE the user data which was carried in the transmission that the host computer initiated, in accordance with the teachings of the embodiments described throughout this disclosure. In an optional fourth step 1940, the UE executes a client application associated with the host application executed by the host computer.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In a first step 2010 of the method, the host computer provides user data. In an optional substep (not shown) the host computer provides the user data by executing a host application. In a second step 2020, the host computer initiates a transmission carrying the user data to the UE. The transmission may pass via the base station, in accordance with the teachings of the embodiments described throughout this disclosure. In an optional third step 2030, the UE receives the user data carried in the transmission.

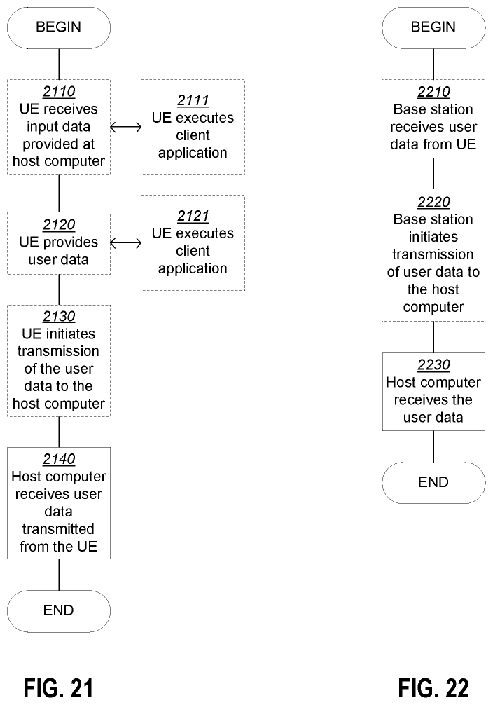

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In an optional first step 2110 of the method, the UE receives input data provided by the host computer. Additionally or alternatively, in an optional second step 2120, the UE provides user data. In an optional substep 2121 of the second step 2120, the UE provides the user data by executing a client application. In a further optional substep 2111 of the first step 2110, the UE executes a client application which provides the user data in reaction to the received input data provided by the host computer. In providing the user data, the executed client application may further consider user input received from the user. Regardless of the specific manner in which the user data was provided, the UE initiates, in an optional third substep 2130, transmission of the user data to the host computer. In a fourth step 2140 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In an optional first step 2210 of the method, in accordance with the teachings of the embodiments described throughout this disclosure, the base station receives user data from the UE. In an optional second step 2220, the base station initiates transmission of the received user data to the host computer. In a third step 2230, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1.-59. (canceled)

60. A method in a first terminal device, the method comprising:
transmitting to a second terminal device a first message indicating a first sidelink Access Stratum (AS) configuration;
receiving from the second terminal device a second message indicating a failure of the first sidelink AS configuration; and
transmitting to a network device a report regarding the failure of the first sidelink AS configuration, wherein the report contains one or more of the following:
an indicator indicating the failure of the first sidelink AS configuration, or
an identification of the second terminal device.

61. The method of claim 60, wherein:
the second message also indicates one or more configuration parameters, of the first sidelink AS configuration, that the second terminal device is not able to comply with; and
the report includes the one or more configuration parameters.

62. The method of claim 61, wherein the one or more configuration parameters include a Sidelink Radio Bearer (SLRB) configuration parameter.

63. The method of claim 61, wherein the report also includes identification of one or more of the following:
the first terminal device; and
a Sidelink Radio Bearer (SLRB) associated with the failure.

64. The method of claim 60, further comprising, in response to the second message, transmitting to the second terminal device a third message indicating a second sidelink AS configuration.

65. The method of claim 64, wherein the second sidelink AS configuration contains one of the following: a full sidelink AS configuration, or a difference from the first sidelink AS configuration.

66. The method of claim 64, wherein:
the second message also indicates one or more configuration parameters, of the first sidelink AS configuration, that the second terminal device is not able to comply with; and
the method further comprises determining the second sidelink AS configuration based on the one or more configuration parameters indicated by the second message.

67. The method of claim 66, wherein the one or more configuration parameters include a Sidelink Radio Bearer (SLRB) configuration parameter.

68. The method of claim 64, wherein:
the second message further indicates at least one candidate sidelink AS configuration that the second terminal device is able to comply with; and
the method further comprises selecting the second sidelink AS configuration from the at least one candidate sidelink AS configuration.

69. The method of claim 64, further comprising receiving from the network device a fourth message indicating the second sidelink AS configuration.

70. A method in a first terminal device, the method comprising:
transmitting to a second terminal device a first message indicating a sidelink Access Stratum (AS) configuration;
receiving from the second terminal device a second message indicating a failure of the sidelink AS configuration; and
releasing one of the following associated with the failure: a sidelink connection, or a Sidelink Radio Bearer (SLRB).

71. The method of claim 70, further comprising determining that no other sidelink AS configuration is usable for the sidelink connection or the SLRB associated with the failure, wherein releasing the sidelink connection or the SLRB is responsive to the determining.

72. The method of claim 71, wherein the second message also indicates one or more configuration parameters, of the sidelink AS configuration, that the second terminal device is not able to comply with, and the determining is based on the one or more configuration parameters indicated by the second message.

73. The method of claim 72, wherein the one or more configuration parameters include an SLRB configuration parameter.

74. The method of claim 71, wherein the second message also indicates at least one candidate sidelink AS configuration that the second terminal device is able to comply with, and the determining is based on the at least one candidate sidelink AS configuration.

75. The method of claim 70, further comprising transmitting to a network device a notification that the sidelink connection or the SLRB has been released.

76. The method of claim 71, further comprising:
transmitting to a network device a report regarding the failure of the sidelink AS configuration; and
receiving from the network device an indication that no other sidelink AS configuration is usable for the sidelink connection or the SLRB,
wherein releasing the sidelink connection or the SLRB is responsive to receiving the indication from the network device.

77. The method of claim 76, wherein:
the second message also indicates one or more configuration parameters, of the sidelink AS configuration, that the second terminal device is not able to comply with; and
the report includes the one or more configuration parameters.

78. A method in a second terminal device, the method comprising:
receiving from a first terminal device a first message indicating a sidelink Access Stratum (AS) configuration; and
transmitting to the first terminal device a second message indicating a failure of the sidelink AS configuration, wherein the second message also indicates one of the following:
one or more configuration parameters, of the sidelink AS configuration, that the second terminal device is not able to comply with, or
at least one candidate sidelink AS configuration that the second terminal device is able to comply with.

79. A method in a second terminal device, the method comprising:
receiving from a first terminal device a first message indicating a sidelink Access Stratum (AS) configuration;
detecting a failure of the sidelink AS configuration at the second terminal device; and
releasing a sidelink connection or a Sidelink Radio Bearer (SLRB) associated with the failure.
